(19) United States
(12) Patent Application Publication
(10) Pub. No.: US 2006/0225764 A1
(43) Pub. Date: Oct. 12, 2006

(54) Flossing device

(76) Inventor: Joe Mark, Mission Viejo, CA (US)

Correspondence Address: TONG & ASSOCIATES, 5850 ANOGA AVENUE, SUITE #400, WOODLAND HILLS, CA, 91367, US

(21) Appl. No.: 11/088,572

(22) Filed: Mar. 23, 2005

(51) Int. Cl. A61C 15/00

(52) U.S. Cl. 132/321

(57) ABSTRACT

A dental floss comprising a first threader, a first cleaner connected to the first threader, the first threader being configured to facilitate insertion of the first cleaner in between at least two teeth, the first cleaner being configured to come in contact with a surface of at least one tooth, the first threader and the first cleaner forming a first flossing unit, a second threader connected to the first cleaner, a second cleaner connected to the second threader, the second threader and the second cleaner forming a second flossing unit configured to be used separate from the first flossing unit, a housing configured to store at least one of the flossing unit; and a spindle attached to the housing where the first and second flossing units may be wound.

### CROSS REFERENCES TO RELATED APPLICATIONS

None

### FIELD OF INVENTION

The present invention relates to flossing devices, particularly flossing devices designed to clean bridges.

### BACKGROUND

Various improvements to conventional dental floss design have been made, such as improvements geared toward enhancing the contact surface of the floss with the inter-proximal surfaces of the teeth. For instance, the flossing device disclosed in US 2003/0154998 by Falleiros et al. Falleiros appears to disclose a textured dental floss having countoured sections. U.S. Pat. No. 5,316,028 issued to Flemming appears to disclose a dental floss having multiple brush portions of varying diameters and a string portion, which has a smaller diameter than the brush portions.

Other improvements to conventional dental floss design are geared toward improving the ease of use of the floss. For instance, U.S. Pat. No. 4,974,614 issued to Selker appears to disclose dental flosses have wide portions that make the floss easier for the users to hold than a conventional dental floss.

None of the above references are geared towards improving dental flosses designed for use with dental bridges. A dental bridge is an artificial tooth used to replace one or more teeth. One commonly used dental bridge is placed in between two natural molars. The dental bridge is typically supported by the two natural molars (hereinafter “abutment” teeth), such as by designing a frame that would wrap around each of the abutment tooth.

Conventional methods of flossing through a dental bridge include using a floss threader shown in FIG. 1. The conventional floss threader 30 typically includes a guiding portion 22 and an elongated material 24 that is shaped to form a loop 26 and is attached to the guiding portion 22. The guiding portion 22 is typically hard in texture to facilitate the insertion of conventional floss. The conventional floss 28 is usually threaded around the loop 26. The user then inserts the guiding portion 22 of the threader 30 through the space between the bridge 34 and the abutment tooth 32a to introduce the conventional floss 28 in the area the user desires to floss. The user then flosses as he normally would holding the guiding portion 22 with one hand and the conventional floss 28 with the other hand.

As seen in FIG. 1, the user of a floss threader has to buy two types of flossing materials—the conventional floss and the floss threader. Additionally, the user has to create his own bridge flossing device each time he flosses his bridge. That is, the user has to thread conventional floss 28 through the threader 30 each time he wants to floss his bridge. This can be an inconvenient process. This conventional bridge flossing method can also take up plenty of conventional cleaner portion from the user. It is desirable to have a bridge flossing device that can be purchased as a single unit and that eliminates having to thread conventional floss around the floss threader when flossing a bridge.

Other existing devices designed for cleaning bridges include the device in U.S. Pat. No. 4,832,063 issued to Smole. However, the device in '063 appears to be a single use device that provides only one set of floss for use. If the user desires to store multiple sets of the '063 device, the user may find it inconvenient to store or group the multiple sets, as no storage unit or grouping mechanism is included. Additionally, the set may readily be exposed to germs, dirt, or bacteria, as there is no storage unit provided.

Other devices for cleaning bridges include the devices U.S. Pat. No. 3,896,824, U.S. Pat. No. 4,008,727, and U.S. Pat. No. 5,316,028, all of which are issued to Thornton. '824 and '727 appear to be single set devices having no storage units, and thus suffer from the same disadvantages as '063. '028 appears to disclose a plurality of flossing devices packaged as a continuous length of textured yarn. However, it appears '028 would require a user to use a cutting tool, such as a scissor to separate one floss unit for use. Additionally, it may be inconvenient to store the plurality of flossing devices of '028, as the continuous length of textured yarn can tangle. Furthermore, no storage unit is included, and the flossing devices may readily be exposed to germs, dirt, or bacteria. It is desirable to have a flossing device for bridges that does not substantially have the disadvantages of the references cited above.

### BRIEF DESCRIPTION OF EMBODIMENTS OF THE PRESENT INVENTION

A dental floss comprising a first threader, a first cleaner connected to the first threader, the first threader being configured to facilitate insertion of the first cleaner in between at least two teeth, the first cleaner being configured to come in contact with a surface of at least one tooth, the first threader and the first cleaner forming a first flossing unit, a second threader connected to the first cleaner, a second cleaner connected to the second threader, the second threader and the second cleaner forming a second flossing unit configured to be used separate from the first flossing unit, a housing configured to store at least one of the flossing unit; and a spindle attached to the housing where the first and second flossing units may be wound.

The above description sets forth, rather broadly, a summary of embodiments of the present invention so that the detailed description that follows may be better understood and contributions of the present invention to the art may be better appreciated. Some of the embodiments of the present invention may not include all of the features or characteristics listed in the above summary. There may be, of course, other features of the invention that will be described below and may form the subject matter of claims. In this respect, before explaining at least one embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a schematic diagram showing a conventional method and device for flossing a surface of a dental bridge.

FIG. 2 is substantially a schematic diagram of the components of a preferred embodiment of the flossing of the present invention.

FIG. 3 is substantially a front view of threader portion of the present invention having a perforation.

FIG. 4 is substantially a side perspective view of an embodiment of the flossing device of the present invention.

FIG. 5 is substantially a view of the interior of a housing embodiment of the flossing device of the present invention.

FIG. 6 is substantially a side perspective view of an embodiment of the flossing device of the present invention having a door that provides access to a compartment of the housing.

### DESCRIPTION OF THE PREFERRED EMBODIMENTS

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention. Also, it is to be understood that the phraseology and terminology employed herein are for the purpose of description and should not be regarded as limiting.

As seen in FIG. 2, the present invention comprises a flossing device, generally indicated by reference number 40. The flossing device 40 preferably includes a plurality of alternating bridge threader portions 42a-c and cleaner portions 44a-c. Each bridge threader portion 42 is preferably attached to a cleaner portion 44. Cleaner portion 44 may be made of materials typically used for manufacturing conventional cleaner portions. Bridge threader portion 42 is preferably made of substantially stiff filament of material, such as nylon and polymers, such as those used for the conventional floss threader, which is known in the art. Bridge threader portion 42 is preferably stiffer than cleaner portion 44 and has stiffness that would allow the bridge threader portion 42 to facilitate the insertion of the cleaner portion 44 through the space between an abutment tooth and a bridge.

Each bridge threader portion 42 and cleaner portion 44 preferably has consistent and predefined lengths. For instance, bridge threader portion 42 preferably has a length of 2.5 inches. Cleaner portion 44 preferably has a length of 22 inches. Of course, the above lengths can be adjusted and still fall within the spirit of the invention. The plurality of alternating and connected bridge threader portions 42 and cleaner portions 44 are preferably wound around a floss housing 46, which is discussed below.

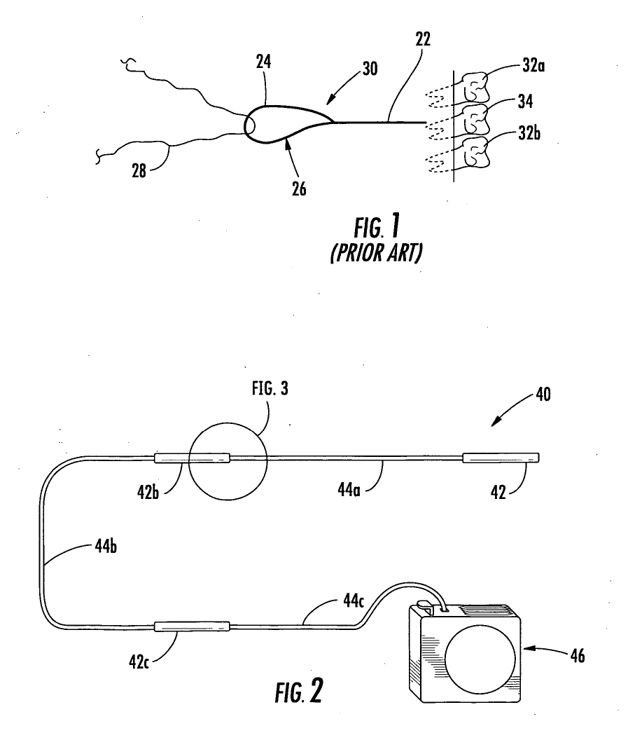

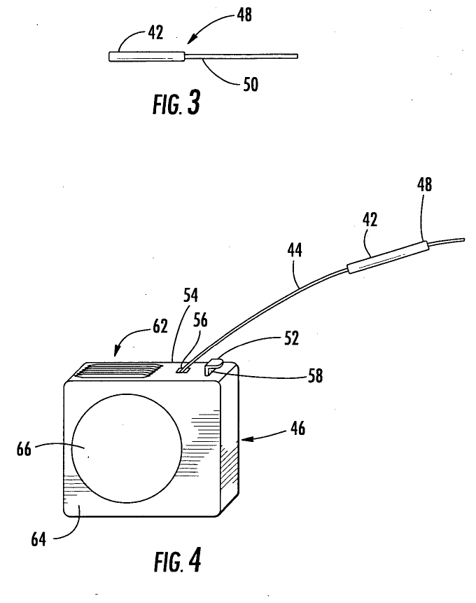

Referring now to FIG. 3, bridge threader portion 42 preferably has a marked area 48 indicating the ideal position for the user to cut when separating a set for use comprising one bridge threader portion 42 and one cleaner portion 44. The marked area is preferably positioned substantially proximate to a leading end 50 of the bridge threader portion 42. The marked area 48 may comprise a nick, a perforation, a label, or indicia. The nick or perforation may be created using a mold that creates said nick or perforation. If the marked area 48 is a label or indicia, the label or indicia may be made of various inks or paint known in the art.

Referring now to FIG. 4, the plurality of alternating and connected bridge threader portions 42 and cleaner portions 44 is preferably stored in a floss housing 46. Floss housing 46 preferably has interconnected top, bottom, right side, left side, front, and rear walls. At least one of the walls may include a plurality of distance markings (not shown) resembling a ruler for measuring the lengths of the floss units being taken from the housing. The top wall 54 of the housing 46 preferably defines a floss passage 56 where the plurality of alternating and connected bridge threader portions 42 and cleaner portions 44 comes out of the housing 46 for access by a user. A floss cutter 52 is preferably attached on the top wall preferably adjacent to the floss passage 56. The cutter 52 is preferably made of stainless steel, aluminum, or other materials known in the art. The cutter 52 preferably includes an edge 58 sharp enough to incise bridge threader portion 42.

Also attached to the top wall 54 of the housing 46 is preferably at least one toothpick 62. The toothpick 62 may be made of paper, wood, or other materials known in the art. The front wall 64 of the housing 46 preferably includes a mirror 66 attached thereto. The mirror 66 may be a magnified mirror. It can be appreciated that the mirror 66 can be used by the user when cleaning his teeth with a toothpick or the flossing device of the present invention.

Referring now to FIG. 5, floss housing 46 preferably includes a wheel 68 positioned inside the interconnected walls of the housing 46. The plurality of alternating and connected bridge threader portions 42 and cleaner portions 44 are preferably wound around the wheel 68 to facilitate the dispensing thereof. Floss housing 46 preferably includes a separator 70, which defines a compartment 70 for the bridge threader portions 42 and cleaner portions 44 and a compartment 72 for a breath freshener 74. Flossing device 40 preferably includes a breath freshener 74, which may be stored within the housing 46 and within compartment 72. The breath freshener 74 may be stored in a spray container or may be in a form of a tablet or an edible film known in the art.

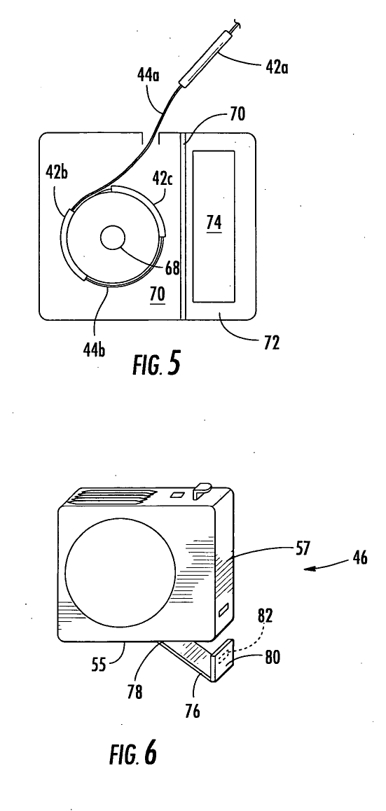

With reference now to FIG. 6, the bottom wall 55 of the housing 46 preferably includes a door section 76, which is configured to open and close to give the user access to the breath freshener 74 (seen in FIG. 5). The door section 76 preferably starts from the portion of the bottom wall beneath the separator 70 (seen in FIG. 5) and runs up to the right side wall 57. The door section 76 preferably includes a crease 78 positioned on the bottom wall 55 substantially beneath the separator 70. The door section 76 preferably further includes a side wall 80 configured to abut the right side wall 57 of the housing 46 when the door section 76 is in a closed position. The door section 76 may include a tab 82 configured to snap in place in a tab receiving portion 84, which is in a form of a recess defined by the right side wall 57 of the housing 46.

It can now be realized that the present invention provides a plurality of flossing devices for bridges that is conveniently organized and can easily be detached from another. The plurality of flossing devices is stored in a housing that protects exposure of the flossing devices to germs, dirt, or bacteria. Each flossing device of the present invention includes a threader portion that allows for easy insertion of the cleaner portion into the area of the teeth desired to be cleaned. The threader portion and the cleaner portion come as one unit, and the user does not have to purchase a threader and a conventional dental floss. The flossing device of the present invention may include the added convenience of a mirror, a toothpick, and a breath freshener, which makes the flossing device ideal for a promotional material that can be given away to people, such as people riding in airplanes, to promote a brand name or a company name.

Although the description above contains many specifications, these should not be construed as limiting the scope of the invention but as merely providing illustrations of some of presently preferred embodiments of this invention. For example, the predefined lengths of the threader portions and the cleaner portions may be modified. The positions of the toothpick, the mirror, and the breath freshener relative to the housing may be altered. The cutter, the toothpick, the mirror, or the breath freshener may be eliminated. The invention is capable of other embodiments and of being practiced and carried out in various ways. The invention is not limited in its application to the details of the construction and to the arrangement of the components set forth in the above description or as illustrated in the drawings.

What is claimed is:

1. A dental floss comprising;
a plurality of connected and alternating threader portion and cleaner portion, each of the threader portion comprising a sturdy material that is harder in texture than the cleaner portion; and
a marked area designated for cutting the dental floss to separate at least one dental floss unit, wherein the threader portion may be used as a leading material to introduce the cleaner portion into a bridge area, the bridge area being surrounded by at least one bridge and one gum, so that a user may use the cleaner portion to remove objects from the bridge area.

2. The dental floss of claim 1, wherein the threader portion comprises a diameter that is larger than the diameter of the cleaner portion.

3. The dental floss of claim 1, further comprising a perforation positioned at the marked area.

4. The dental floss of claim 1, further comprising a housing configured to contain the plurality of connected and alternating threader and cleaner portions.

5. The dental floss of claim 4, further comprising a floss cutter attached to the exterior of the housing.

6. The dental floss of claim 4, further comprising a mirror attached to the exterior of the housing.

7. The dental floss of claim 4, further comprising at least one toothpick removeably attached to the exterior of the housing.

8. The dental floss of claim 4, further comprising at least one breath freshener removeably positioned within the housing.

9. A dental floss comprising:
a continuous length of flossing devices, each flossing device comprising a threader portion and a cleaner portion, the threader portion being configured to facilitate the insertion of the cleaner portion through a bridge area desired to be cleaned, the cleaner portion being configured to contact at least one tooth surface thereby cleaning the tooth surface, the threader portion being on a first end and the cleaner portion being on a second end, the threader portion having a diameter that is larger than the cleaner portion, the threader portion being harder in texture than the cleaner portion;
a housing configured to contain a portion of the continuous length of flossing devices; and
a spindle positioned inside the housing where the continuous length of flossing devices may be wound.

10. The dental floss of claim 9, further comprising a perforation positioned at the marked area.

11. The dental floss of claim 9, further comprising a floss cutter attached to the exterior of the housing.

12. The dental floss of claim 9, further comprising a mirror attached to the exterior of the housing.

13. The dental floss of claim 9, further comprising at least one toothpick removeably attached to the exterior of the housing.

14. The dental floss of claim 9, further comprising at least one breath freshener removeably positioned within the housing.

15. A dental floss comprising:
a first threader;
a first cleaner connected to the first threader, the first threader being configured to facilitate insertion of the first cleaner in between at least two teeth, the first cleaner being configured to come in contact with a surface of at least one tooth, the first threader and the first cleaner forming a first flossing unit;
a second threader connected to the first cleaner;
a second cleaner connected to the second threader, the second threader and the second cleaner forming a second flossing unit configured to be used separate from the first flossing unit;
a housing configured to store at least one of the flossing unit; and
a spindle attached to the housing where the first and second flossing units may be wound.

16. The dental floss of claim 15, wherein the first threader portion comprises a diameter that is larger than the diameter of the first cleaner portion.

17. The dental floss of claim 15, further comprising a perforation positioned substantially in between the first and second flossing units.

18. The dental floss of claim 15, further comprising a floss cutter attached to the exterior of the housing.

19. The dental floss of claim 15, further comprising a mirror attached to the exterior of the housing.

20. The dental floss of claim 15, further comprising at least one toothpick removeably attached to the exterior of the housing.
